(19) United States
(12) Patent Application Publication
(10) Pub. No.: US 2008/0278303 A1
(43) Pub. Date: Nov. 13, 2008

(54) ANTI-IDLING ALARM AND METHOD FOR VEHICLES

(76) Inventor: DANIEL B. WINSLOW, NORFOLK, MA (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/098,673

(22) Filed: Apr. 7, 2008

Related U.S. Application Data
(60) Provisional application No. 60/922,629, filed on Apr. 10, 2007.

(51) Int. Cl. B60R 27/00

(52) U.S. Cl. 340/441

(57) ABSTRACT

An anti-idling alarm, comprising a microcontroller, an interface connected to vehicle sensors, a communication interface connected to the microcontroller, a data storage arrangement connected to the microcontroller and at least one warning arrangement configured to be activated by the microcontroller.

### CROSS-REFERENCE TO RELATED APPLICATIONS

This application seeks priority to U.S. Provisional Patent Application 60/922,629, filed Apr. 10, 2007, the entirety of which is incorporated by reference.

### FIELD OF THE INVENTION

Aspects of the invention relate to systems to improve environmental regulation compliance and to reduce fuel consumption and costs. More specifically, aspects of the invention provide an anti-idling alarm system for motor vehicles.

### BACKGROUND INFORMATION

There is an urgent need to reduce the amount of air pollution and fuel consumption from internal combustion engines. In order to address this need, many local, state and federal governments have active regulations on the maximum duration a vehicle can remain idle with its engine running. In states such as Massachusetts and California, vehicles are prohibited from idling in excess of five minutes with civil and criminal penalties for violation. As result, many transportation and construction companies have a need to implement processes and controls to minimize violation of these new regulations and to reduce the costs of fuel.

Currently, conventional technologies, such as shut off devices, are potentially dangerous because during operation there is an unexpected loss of auxiliary power for the internal combustion engine. Thus, the vehicle operators are not informed of an impending engine shut off, increasing the risk to the operator in the vehicle, or malfunction of auxiliary systems in the vehicle that rely on engine power.

There is a need to provide an apparatus and method to reduce the amount of air pollution and fuel consumption from internal combustion engines at idle.

There is a further need to provide an apparatus and method to reduce the amount of air pollution and fuel consumption from internal combustion engines wherein these apparatus and methods can be easily retrofitted to existing internal combustion engine technology.

There is also a need to provide an apparatus and method is cost-effective in performing the reduction of the amount of air pollution and fuel consumption from the internal combustion engine.

### SUMMARY OF THE INVENTION

It is therefore an objective of an embodiment of the invention to provide an apparatus and method to reduce the amount of air pollution and fuel consumption from internal combustion engines at idle.

It is also an objective of an embodiment of the invention to provide an apparatus and method to reduce the amount of air pollution and fuel consumption from internal combustion engines wherein these apparatus and methods can be easily retrofitted to existing internal combustion engine technology.

It is a further objective of an embodiment of the invention to provide an apparatus and method that is cost-effective in performing the reduction of the amount of air pollution and fuel consumption from the internal combustion engine.

The objectives of the invention are achieved as illustrated and described.

In one embodiment an anti-idling alarm is provided comprising a microcontroller, an interface connected to vehicle sensors, a communication interface connected to the microcontroller, a data storage arrangement connected to the microcontroller, and at least one warning arrangement configured to be activated by the microcontroller.

In another aspect, the anti-idling alarm described above is configured such that the at least one warning arrangement is configured to be activated by the microcontroller is a first light arrangement and a horn.

In another aspect, the anti-idling alarm described above is configured wherein the at least one warning arrangement configured to be activated by the microcontroller is a first light arrangement connected to a power relay switch and a horn connected to a power relay switch.

In another aspect, the anti-idling alarm described above further comprises a power converter connected to the microcontroller.

In another aspect, the anti-idling alarm described above further comprises a remote access port connected to the communication interface.

In another aspect, the anti-idling alarm further comprises a connection configured to transfer information between the microcontroller and a vehicle controller area network.

In a further aspect, the anti-idling alarm further comprises a remote access terminal configured to receive information through a remote access port and a communication interface.

In a still further aspect, a method for alerting at least one individual of a vehicle idle condition is presented, comprising operating a vehicle with an internal combustion engine, monitoring at least one of a brake engaged sensor, an engine monitor sensor, and a vehicle speed sensor to determine when the vehicle is idling, and alerting the vehicle operator of the vehicle idle condition.

In a still further aspect, a method for alerting at least one individual is provided wherein the alerting the vehicle operator of the vehicle idle condition is through lighting a light arrangement.

In a still further aspect, the method for alerting at least one individual is provided such that the alerting the vehicle operator of the vehicle idle condition is through activating a horn.

In a still further aspect, the method further comprises reading an alert of a vehicle idle condition from a remote access terminal.

In a still further aspect, a program storage device readable by machine, tangibly embodying a program of instructions executable by the machine to perform method steps for alerting at least one individual of a vehicle idle condition is presented. The method comprises operating a vehicle with an internal combustion engine, monitoring at least one of a brake engaged sensor, an engine monitor sensor, and a vehicle speed sensor to determine when the vehicle is idling, and alerting the vehicle operator of the vehicle idle condition.

In another aspect, the program storage device is presented wherein the method accomplished by the device is performed such that the alerting of the at least one individual of the vehicle idle condition is through lighting a light arrangement.

In another aspect, the program storage device is presented such that the method accomplished by the device is performed such that the alerting the at least one individual of the vehicle idle condition is through activating a horn.

In another aspect, the program storage device is presented wherein the method accomplished by the device further comprises reading an alert of a vehicle idle condition from a remote access terminal.

### BRIEF DESCRIPTION OF THE DRAWINGS

FIG. 1 is a block diagram of an anti-idling alarm system.

FIG. 2 is a top view of a microcontroller used for the anti-idling alarm system of FIG. 1.

### DETAILED DESCRIPTION

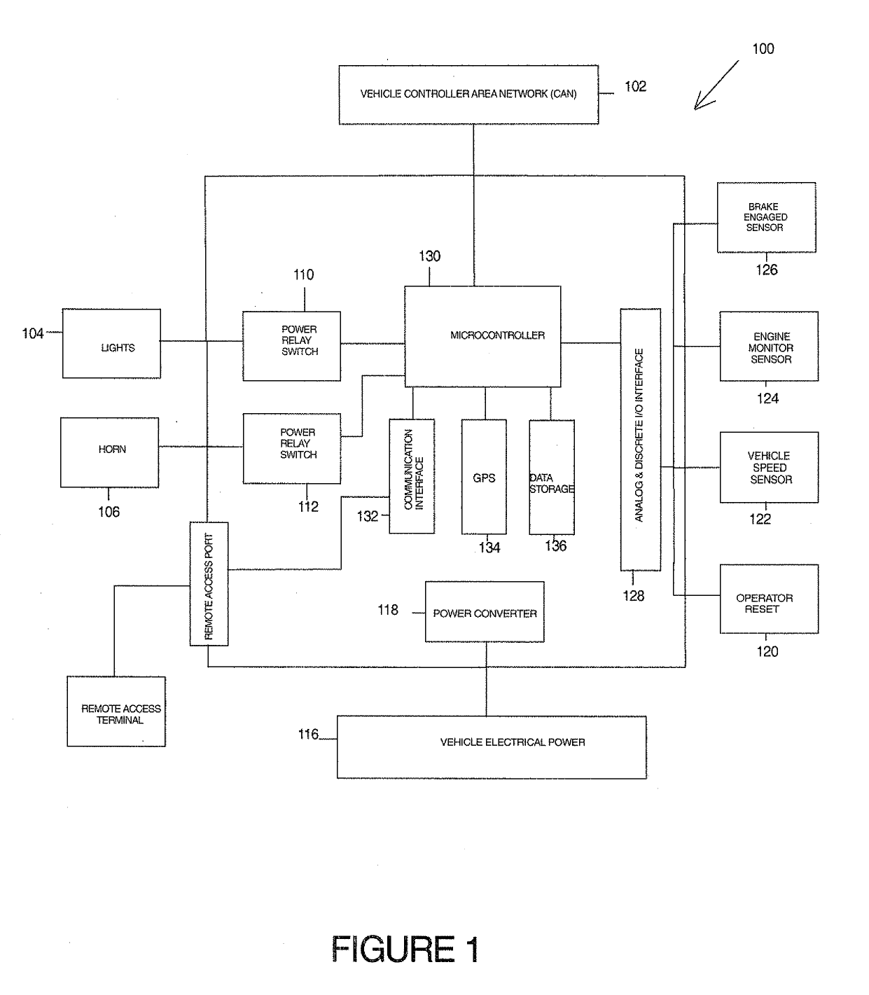

Referring to FIG. 1, a system 100 to minimize environmental consequences and fuel consumption of idling a internal combustion engine is provided. In this system 100, a microcontroller 130 controls functions for notifying a driver when the internal combustion engine has exceeded a preset time of idling. Under various environmental regulations, internal combustion engines may not idle for more than a preset amount of time due to environmental restrictions. These restrictions include inappropriate burning of fossil fuels and air emissions from the internal combustion engine. In various areas of the United States, restrictions are placed upon internal combustion engine idling as this idling needlessly spreads contaminants to the environment and wastes fuel

The microcontroller 130 accepts information from a brake engaged sensor 126, an engine monitor sensor 124, a vehicle speed sensor 122 and an operator reset arrangement 120. In an alternative embodiment, a sensor from the transmission may be used instead the brake engaged sensor 126, such that when a transmission is in the “park” mode, signals are transmitted to the microcontroller 130. The inputs from the brake engaged sensor 126, engine monitor sensor 124, vehicle speed sensor 122, and operator reset 120 are fed to an analog and discrete input output interface 128. The output of the analog interface 128 is provided to the microcontroller 130. The microcontroller 130 also interfaces with a communication interface 132, a global positioning system, if any 134, and data storage 136. The microcontroller 130 is also connected to the vehicle controller area network 102 to interface with other vehicle systems. The microcontroller 130 is further connected to a power relay switch 110 and in turn is connected to a light arrangement 104 as well as a power relay switch 112 and a horn 106.

In the illustrated embodiment provided, the light arrangement 104 may be a dashboard light, exterior lights or a check engine light that illuminates upon activation of the power relay switch 110 controlled by the microcontroller 130. Alternatively, the horn 106 is an audible alarm placed within the passenger compartment of the vehicle or the vehicle horn and is activated by a power relay switch 112 controlled by the microcontroller 130. Thus, the light arrangement 104 and the horn 106 provide both visual and audible alerts as to exceed ends of the idling time allowed by regulation.

Vehicle electric power 116 is provided to a power converter 118 that feeds various systems of the microcontroller 130, the power relay switch 110 112, the communication interface 132, the ground positioning system, if any 134, the data storage 136 and analog and discrete input output interfaces 128. Other connections to the vehicle controller area network 102 are provided.

In the illustrated embodiment, the system 100 may be adapted to different makes and ages of vehicles in order to monitor vehicle equipment. For newer vehicles, the system may be able to connect directly to a vehicle controller area network 102 and obtain necessary vehicle status information from the network 102.

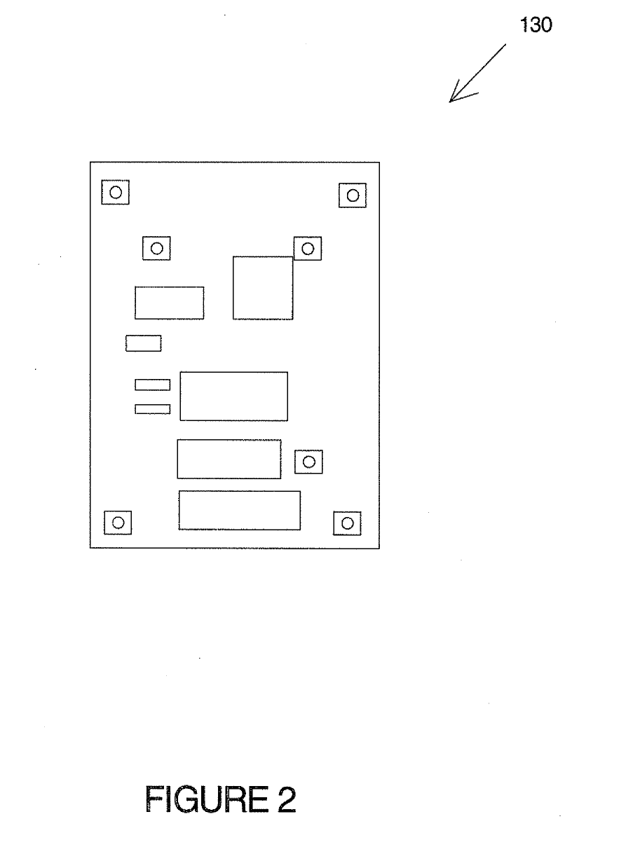

Referring to FIG. 2, the microcontroller 130 of FIG. 1 is illustrated. In this embodiment, a single board computer utilizes a 68HC11F1′ microprocessor. Is equipped with up to 20 digital I/O lines, two serial RS-232/485 ports, LCD and keypad interface, 8 channels of analog to digital converters and 4 channels of digital to analog converters. Peripheral interfaces can include CAN 102, sensor signals 126, 124, 122, 120 GPS 134, data storage 136 and activation signals for the audio/visual power relays 110, 112.

Differing alarm methods may be used to indicate idle connections to a driver. In one example embodiment, a visual alarm is provided that enables vehicle lights to flash when an idle alarm is triggered. A default setting, for example, may be an intermittent flash every 1 to 2 seconds. An audible alarm method may also be provided such that a vehicle for an audio system may be enabled when the idle alarm is triggered. A default setting may be, for example, an intermittent beep every 0.5 to 1 seconds. The audible alarm and the visual alarm may “time out” after a specified period of time.

In one example embodiment, the system 100 is capable of operating while the vehicle power is off. The system 100 is also configured to withstand the operating and non-operating environmental conditions on the intended vehicle.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. An anti-idling alarm, comprising:
a microcontroller;
an interface connected to vehicle sensors;
a communication interface connected to the microcontroller;
a data storage arrangement connected to the microcontroller; and
at least one warning arrangement configured to be activated by the microcontroller.

2. The anti-idling alarm according to claim 1, wherein the at least one warning arrangement configured to be activated by the microcontroller is a first light arrangement and a horn.

3. The anti-idling alarm according to claim 2, wherein the at least one warning arrangement configured to be activated by the microcontroller is a first light arrangement connected to a power relay switch and a horn connected to a power relay switch.

4. The anti-idling alarm according to claim 1, further comprising:
a power converter connected to the microcontroller.

5. The anti-idling alarm according to claim 1, further comprising:
a remote access port connected to the communication interface.

6. The anti-idling alarm according to claim 1, further comprising:
a connection configured to transfer information between the microcontroller and a vehicle controller area network.

7. The anti-idling alarm according to claim 1, further comprising:
a remote access terminal configured to receive information through a remote access port and a communication interface.

8. A method for alerting at least one individual of a vehicle idle condition, comprising:
operating a vehicle with an internal combustion engine;
monitoring at least one of a brake engaged sensor or park engaged sensor, an engine monitor sensor, and a vehicle speed sensor to determine when the vehicle is idling; and
alerting the vehicle operator of the vehicle idle condition.

9. The method according to claim 8, wherein the alerting the vehicle operator and others of the vehicle idle condition is through lighting a light arrangement.

10. The method according to claim 8, wherein the alerting the vehicle operator and others of the vehicle idle condition is through activating a horn.

11. The method according to claim 8, further comprising:
recording a global positioning system location of the vehicle.

12. The method according to claim 8, further comprising:
reading an alert of a vehicle idle condition from a remote access terminal.

13. A program storage device readable by machine, tangibly embodying a program of instructions executable by the machine to perform method steps for alerting at least one individual of a vehicle idle condition, comprising:
operating a vehicle with an internal combustion engine;
monitoring at least one of a brake engaged sensor, an engaged park sensor, an engine monitor sensor, and a vehicle speed sensor to determine when the vehicle is idling; and
alerting the at least one individual of the vehicle idle condition.

14. The program storage device according to claim 13, wherein the method accomplished by the device is performed such that the alerting the vehicle operator and others of the vehicle idle condition is through lighting a light arrangement.

15. The program storage device according to claim 13, wherein the method accomplished by the device is performed such that the alerting the vehicle operator and others of the vehicle idle condition is through activating a horn.

16. The program storage device according to claim 13, wherein the method accomplished by the device further comprises:
reading an alert of a vehicle idle condition from a remote access terminal.
